(19) United States
(12) Patent Application Publication
(10) Pub. No.: US 2025/0090877 A1
(43) Pub. Date: Mar. 20, 2025

(54) FACE MASK

(71) Applicants: THE UNIVERSITY OF BIRMINGHAM, Birmingham (GB); KING'S COLLEGE LONDON, London (GB)

(72) Inventors: Owen Addison, London (GB); Luke Carter, Birmingham (GB); Sophie Cox, Birmingham (GB); Trevor Coward, London (GB); Caroline Reed, London (GB); Liam Grover, Birmingham (GB)

(21) Appl. No.: 18/247,357

(22) PCT Filed: Sep. 22, 2021
(86) PCT No.: PCT/EP2021/076089

§ 371 Date: Mar. 30, 2023

(30) Foreign Application Priority Data
Sep. 30, 2020 (GB) 2015499.3

(51) Int. Cl. A62B 18/08; A41D 13/11; A62B 23/02

(52) U.S. Cl. CPC A62B 18/08; A41D 13/1138; A62B 23/025

(57) ABSTRACT

A particle filtering face half mask (100) configured to provide respiratory protection and to contact a nasal region, cheeks and a chin of a user. The face half mask (100) comprises a main body (102) configured to cover nostrils and a mouth of a user, and a seal (104) configured to form an interface between the main body (102) and a skin surface of the user, the seal (104) configured to prevent the ingress of undesired particles into the face half mask (100). The seal (104) is releasably connectable to a perimeter of the main body (102).

### TECHNICAL FIELD

The invention relates to a particle filtering face half mask. In particular, the invention relates to a particle filtering face half mask configured to contact a nasal region, cheeks and chin of a user.

### BACKGROUND

The SARS-COV-2 virus pandemic has highlighted the need for respiratory personal protective equipment, PPE, that provides effective protection and can be comfortably worn by users over long periods.

Respiratory PPE typically covers at least the nostrils and mouth of a user, and may take the form of a respiratory device or face mask. Respiratory PPE may be required in a number of settings, for example medical settings and construction settings, to protect the wearer from the inhalation of undesired particles. Assuming that an appropriate filtering material is selected, the effectiveness of respiratory PPE may be in large part dictated by the seal that is formed between the respirator device and the user's face during use. If an effective seal is not formed between the respirator and the user's face, leaks in the facial seal may occur, exposing the user to the ingress into the face mask of undesired particles, such as airborne pathogens or dust for example. On the other hand, if the seal between the face mask and the face of the user is too tight, the user may experience skin abrasions/irritation, bruising and/or discomfort.

Known face masks may comprise gasket-style seals, which rely on sufficient force being applied to the face mask to deform the gasket-style seal to the contours of the wearer's face. In such face masks, the effectiveness of the seal may be determined by how tightly the gasket-style seal is held against the face of the wearer. The increased force required to deform the gasket-style seal and hold it tightly against the skin surface of the wearer may cause abrasions, bruising and/or discomfort particularly in areas of the face with reduced soft tissue, such as the nose and chin.

A further problem associated with known face masks, such as face masks comprising gasket-style seals, is that they may be difficult to clean effectively.

There exists a need to provide a face mask that overcomes the above-mentioned problems.

### SUMMARY

According to the invention in a first aspect, there is provided a particle filtering face half mask configured to contact a nasal region, cheeks and a chin of a user, the particle filtering face half mask configured to provide respiratory protection, the face half mask comprising: a main body configured to cover nostrils and a mouth of a user; and a seal configured to form an interface between the main body and a skin surface of the user, the seal configured to prevent the ingress of undesired particles into the face half mask, and wherein the seal is releasably connectable to a perimeter of the main body.

Optionally, one or both of the seal and the main body comprise connection features for releasable connection between the seal and the main body.

Optionally, the connection features comprise a channel on one of the seal and the main body configured to engage a lip on the other of the seal and the main body.

Optionally, the channel extends around a perimeter of the one of the seal and the main body, and the lip extends around a perimeter of the other of the seal and the main body.

Optionally, the channel extends fully around the perimeter of the one of the seal and the main body, and the lip extends fully around the perimeter of the other of the seal and the main body.

Optionally, at least one wall of the channel is configured to at least partially overlap the lip.

Optionally, at least one wall of the channel is resiliently deformable.

Optionally, the channel is a c-shaped channel.

Optionally, the seal comprises the channel and the main body comprises the lip.

Optionally, the seal is resiliently deformable.

Optionally, the seal comprises a silicone material.

Optionally, the seal comprises a material comprising a Shore A harness scale value of greater than or equal to substantially 15 Shore and less than or equal to substantially 20 Shore.

Optionally, the hardness of the main body is greater than the hardness of the seal.

Optionally, a portion of the seal configured to contact the skin surface of the user comprises a profile corresponding to the nasal region, cheeks and chin of the user.

Optionally, the profile corresponds to the nasal region, cheeks and chin of the user in an undeformed configuration.

Optionally, a portion of the seal configured to extend between the main body and the skin surface of the wearer comprises a minimum thickness. Optionally, the minimum thickness may be substantially 5 mm.

Optionally, at least one of: a portion of the seal configured to extend between the main body and the chin of the user; a portion of the seal configured to extend between the main body and the nose of the user; and a portion of the seal configured to extend between the main body and a maxilla of the user, is of a greater thickness than the minimum thickness.

Optionally, the particle filtering face half mask further comprises a filter.

Optionally, the filter comprises a filter cap configured to receive filter material.

Optionally, the filter cap is removably connectable to the main body.

Optionally, the filter cap comprises head strap connectors configured to engage a head strap for securing the face half mask to a face of the user.

Optionally, the filter cap comprises a plurality of apertures.

Optionally, the particle filtering face half mask comprises the filter material.

Optionally, the particle filtering face half mask comprises a filtering facepiece 3, FFP3, respirator.

Optionally, the particle filtering face half mask is configured to provide protection against airborne pathogens.

### BRIEF DESCRIPTION OF DRAWINGS

FIG. 1 shows an exploded view of an exemplary face mask;

FIG. 2 shows a perspective view of an exemplary main body;

FIG. 3 shows a perspective view of an exemplary seal;

FIG. 4 is a cross section through an exemplary seal;

FIG. 5 shows a perspective view of an exemplary filter cap; and

FIG. 6 shows a rear view of an exemplary face mask.

### DETAILED DESCRIPTION

Generally disclosed herein is a particle filtering half face mask comprising a main body and a seal. The seal is configured to form an interface between the main body and a skin surface of the user. In exemplary arrangements, the seal is releasably connectable to the main body. For the purpose of this specification, releasable connection, or releasable engagement, encompasses a connection that allows detachment of one of the seal and the main body from the other of the seal and the main body. The releasable connection may allow subsequent re-attachment of the seal and the main body. A releasable connection may allow multiple subsequent attachments and detachments. In exemplary arrangements, the seal may be fully detached/separated from the main body. Advantageously, this allows the face mask to be cleaned by soaking the seal and the main body separately.

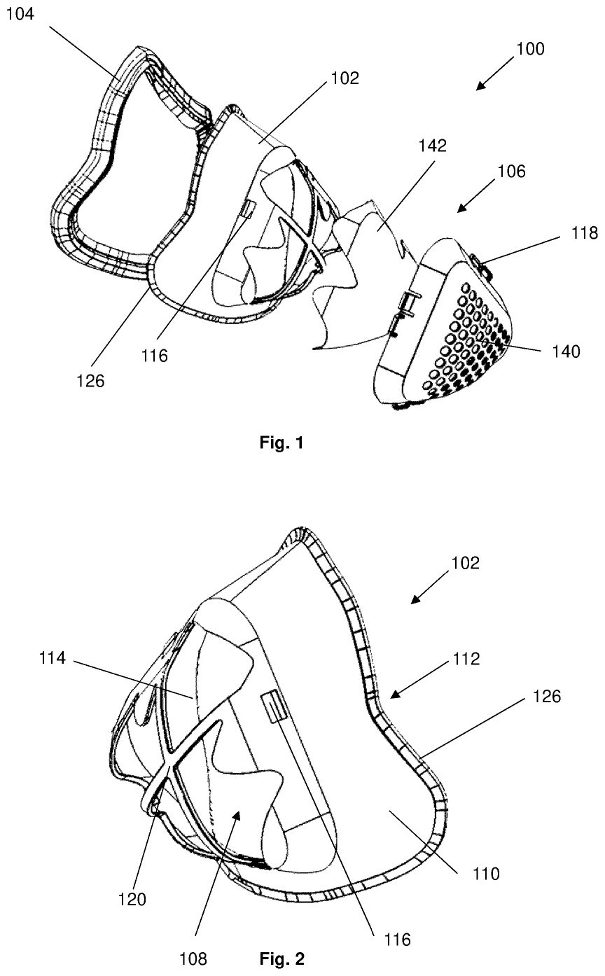

FIG. 1 shows an exemplary face mask 100. The face mask 100 may be a half face mask. That is, the face mask 100 may be configured to extend over a portion of a face of a user (or wearer), as opposed to substantially the whole of the face. The exemplary face mask 100 may be configured to extend over a lower portion of the face of the wearer. In exemplary arrangements, the face mask 100 may comprise an oro-nasal half mask. That is, the face mask may be configured to cover nostrils and a mouth of the user but not extend to cover other orifices such as the eyes. The face mask 100 may be a reusable face mask. That is, a face mask configured to be used for more than a single shift.

The face mask 100 may comprise a particle filtering face mask. A particle filtering face mask is configured to provide protection against particles such as respiratory borne pathogens, solid particles, for example dust, liquids and/or chemicals. As such, the face mask 100 may be suitable for use in a range of fields in which respiratory protection against particles is required. For example, a particle filtering face mask may be suitable for use in medical settings, construction settings and/or laboratory settings.

The face mask 100 may comprise a filtering facepiece, FFP, mask configured to meet the requirements of an FFP1, FFP2 or FFP3 face mask, as defined in the European Standard EN-149.

The exemplary face mask 100 comprises a main body 102 and a seal 104. Exemplary face masks, such as the face mask 100, may comprise a filter 106.

In exemplary face masks, the main body 102 may comprise a shell. The main body 102 may be configured to extend over nostrils and a mouth of a wearer when the face mask 100 is in use. The exemplary main body 102 defines a cavity 108. The cavity 108 is configured to accommodate at least the nostrils and the mouth of a wearer of the face mask 100. The exemplary face mask 100 shown in FIG. 1 is configured to contact and surround a nasal region, cheeks and chin of a user. As such, the cavity 108 of the exemplary face mask 100 may be configured to accommodate at least a portion of the nasal region, at least a portion of the cheeks, and at least a portion of the chin of the wearer.

The cavity 108 may define a breathing chamber through with the breath of the wearer, from the nostrils and mouth, passes when the face mask 100 is in use. The breathing chamber may be defined by a main body wall 110. At least a portion of the cavity 108 may be defined by the filter 106. The main body wall 110 may be configured to direct the breath of the wearer into and out of the main body via the filter 106.

The main body 102 may further comprise a main aperture 112. In exemplary arrangements, at least the nostrils and the mouth of the wearer of the face mask 100 may be accommodated within the main body 102 through the main aperture 112. In exemplary face masks 100, at least a portion of the nasal region, at least a portion of the cheeks, and at least a portion of the chin of the wearer may be accommodated within the main body 102 through the main aperture 112.

The main body 102 may comprise a filter aperture 114. The filter aperture 114 is configured to receive the filter 106, as will be described in more detail below. The filter aperture 114 may be sized such that a sufficient amount of air may enter the breathing chamber. In exemplary arrangements, the filter 106 may be coupled to the main body 102. The main body 102 may comprise connection features 116 configured to engage corresponding connection features 118 of the filter 106 (visible in FIG. 1) to couple the filter 106 thereto. In the exemplary arrangement of FIG. 1, the connection features 118 of the filter 106 comprise biased prongs configured to engage corresponding recesses of the main body 102. A snap fit connection may be formed by the prongs and the recesses. The skilled person will appreciate that in alternative arrangements, the main body 102 may comprise the prongs and the filter 106 may comprise the recesses.

The skilled person will further appreciate that alternative connection features may be provided to the couple the main body 102 and the filter 106. In alternative arrangements, the connection features 116 and 118 may comprise clips and corresponding retention surfaces, screw threads, keyed apertures, or lug and groove arrangements. The skilled person will be able to envisage further arrangements. In the exemplary face mask 100, the filter 106 may be removably connectable to the main body 102. In further alternative arrangements, the filter 106 may be fixedly coupled to the main body 102. That is, is alternative arrangements, the filter 106 may not be separable from the main body 102 once connected to the main body 102.

The exemplary main body 102 shown in FIG. 1 further comprises support trusses 120 configured to support a filter material, as will be described in more detail below. The support trusses 120 may extend over at least a portion of the filter aperture 114.

The exemplary main body 102 shown in FIG. 1 comprises connection features 126 configured to engage corresponding connection features of the seal 104. The connection features 126 of the main body 102 may be configured to releasably engage the connection features of the seal 104. That is, the connection features of the main body 102 and the seal 104 may be configured to allow attachment and subsequent detachment of the one of the main body 102 and the seal 104 from the other of the main body 102 and the seal 104.

In the exemplary arrangement of FIG. 1, the connection features 126 of the main body 102 comprises a lip configured to engage a corresponding channel of the seal 104. The lip may extend laterally from the main body 102. In the exemplary main body 102 of FIG. 1, the lip extends radially outwardly from the wall 110 of the main body 102.

The lip may be configured to engage a channel of the seal 104, as will be described in more detail below. The lip may extend around at least a portion of a perimeter of the main body 102. The exemplary lip shown in FIG. 1 extends fully around the perimeter of the main body 102. The skilled person will appreciate however that in alternative arrangements, the lip may extend around only a portion of the perimeter of the main body 102, or the main body 102 may comprise a plurality of discrete lips separated around the perimeter of the main body 102.

In exemplary arrangements, the main body 102 may be substantially rigid. In exemplary arrangements, the main body 102 may comprise a material of greater hardness than the material of the seal 104. Exemplary main bodies 102 may comprise a rigid polymer material. In exemplary arrangements, the main body may comprise a UV cured resin material.

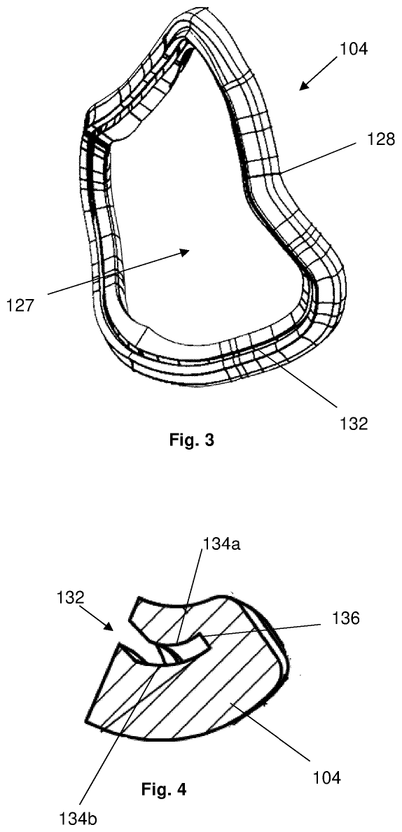

FIG. 3 shows an exemplary seal, which may be the exemplary seal 104 of FIG. 1. In the exemplary face mask 100, the seal 104 is configured to contact a skin surface of the wearer. The seal 104 may form an interface between the main body 102 and a skin surface of the wearer. The seal 104 is configured to prevent the ingress of undesired particles into the face mask 100. That is, the seal 104 is configured to prevent the ingress of undesired particles into the cavity 108 of the main body 102. The seal 104 may be configured to accommodate the main body 102. In exemplary arrangements, the seal 104 may be configured to surround a periphery or perimeter of the main body 102.

The seal 104 may comprise an aperture 127. In exemplary arrangements, at least the nostrils and the mouth of the wearer of the face mask 100 may be accommodated within the main body 102 through the aperture 127 of the seal 104. In exemplary face masks 100, at least a portion of the nasal region, at least a portion of the cheeks, and at least a portion of the chin of the wearer may be accommodated within the main body 102 through the aperture 127 of the seal 104.

The aperture of the seal 127 may substantially correspond to the main aperture 112 of the main body 102.

At least a portion of the seal 104 may be flexible. In exemplary seals, at least part of the seal 104 may be deformable. As will be described in more detail below, the seal 104 may be deformable to allow connection of the seal 104 to the main body, and/or separation of the seal 104 from the main body 102. The term “deformable” or “deform” encompasses bending, deflecting, compressing and/or stretching to change a profile or geometry of the seal. Deformation may encompass one or more of flexible deformation, elastic deformation and plastic deformation. In exemplary arrangements, substantially all of the seal 104 may be deformable.

The exemplary seal 104 may be elastically deformable. Elastic deformation encompasses deformation of the seal 104 without permanent distortion of the seal 104. In such arrangements, the seal 104 may return to its original shape when an applied deformation force is removed. The skilled person will appreciate that in alternative arrangements however, the seal may be plastically deformable. That is, the seal may be permanently deformed and not returned to its original shape when the applied deformation force is removed.

Exemplary seals may be deformable to accommodate a face of a user when the face mask 100 is in use. That is, at least a portion of the seal 104 may be deformable to accommodate a skin surface of the face of the user under an applied force.

The exemplary seal 104 shown in FIGS. 1 and 3 may comprise a profile contoured to a profile of the face of the wearer. That is, a profile 128 of the seal configured to contact the skin surface of the user may substantially correspond to the profile of the face of the wearer. In exemplary face masks 100, which are configured to contact the nasal region, chin and cheeks of the user, the profile 128 of the seal 104 may correspond to the profile of the nasal region, cheeks and chin of the wearer. The profile 128 of the seal configured to contact the skin surface of the wearer may substantially correspond to the profile of the face of the wearer in an undeformed state. That is, a state in which no force is applied to the seal 104 to deform the seal 104. Exemplary seals may comprise profiles that are customised to a wearer's exact facial profile. In alternative arrangements, the seal may comprise a predetermined profile configured to correspond to a predetermined face profile. The predetermined profile may comprise features corresponding to an average face size, shape and contour across a population.

Advantageously, providing a seal comprising a profile configured to correspond to a face of the wearer in an undeformed state reduces the amount of force that needs to be applied to the face mask to compress the seal and provide a good face mask fit. As such, skin abrasions, bruising and/or discomfort may be reduced in comparison to known masks comprising a gasket-style seal, which rely solely on deformation to conform to a face of the wearer, and therefore require higher forces to be applied to the face of the wearer.

The exemplary seal 104 shown in FIG. 3 is releasably connectable to the main body 102. The seal 104 may be releasably connectable to a perimeter of the main body 102.

The seal 104 may comprise connection features 130 configured to releasably engage the corresponding connection features 126 of the main body 102. In the exemplary face mask 100 shown in FIG. 1, the connection features 130 of the seal 104 comprise a channel 132 configured to releasably engage the lip of the main body 102. The channel of the seal 104 may be substantially c-shaped. The skilled person will appreciate that in alternative arrangements, the seal 104 may comprise the lip and the main body 102 may comprise the channel.

The channel may extend around at least partly around a perimeter of the seal 104. The exemplary channel 132 shown in FIG. 3 extends around substantially the whole of the perimeter of the seal 104. However, the skilled person will appreciate that in alternative arrangements, the channel may extend partially around the perimeter of the seal 104. In further arrangements, a series of discrete channels may be formed around the perimeter of the seal. In such arrangements, the series of discrete channels may accommodate corresponding discrete lips on the main body 102.

FIG. 4 shows a cross-section through the seal 104. The exemplary channel 132 comprises opposed walls 134a, 134b. The channel 132 may further comprise a base 136. The lip of the main body 102 may be received in a gap formed by the opposed walls 134a, 134b of channel. The gap formed by the opposed walls 134a, 134b may be smaller than a thickness of the corresponding portion of the lip configured to be received therein. As such, a friction fit is formed between the main body 102 and the seal 104. A portion of the lip may be configured to abut the base 136 of the channel 132 when the lip is received therein.

In exemplary arrangements, at least one of the opposed walls 134a, 134b may be resiliently deformable. In the exemplary seal 104 shown in FIGS. 1, 3 and 4, each of the opposed walls 134a, 134b are resiliently deformable. The at least one opposed wall 134a, 134b may be elastically deformable.

The skilled person will appreciate that alternative connection features 126 and 130 of the main body 102 and the seal 104 respectively may be provided to releasably connect the main body 102 and the seal 104. For example, in alternative arrangements, the connection features 126 and 130 may comprise clips and corresponding retention surfaces, screw threads, keyed apertures, prong and recess or lug and groove arrangements. The skilled person will be able to envisage further arrangements.

At least a portion of the exemplary seal 104 may comprise an elastomer material. In exemplary arrangements, substantially the whole of the seal 104 may comprise an elastomer material. The elastomer may comprise silicone. The silicone may be a biocompatible silicone. In exemplary arrangements, the elastomer may comprise a silicone rubber.

Exemplary seals may comprise a Shore A harness scale value of greater than or equal to substantially 15 Shore. Exemplary seals may comprise a Shore A hardness scale value of greater than or equal to substantially 15 Shore and less than or equal to substantially 20 Shore. The skilled person will appreciate that appropriate hardness values may be achieved using softening agents. For example, a softening agent may be applied to the silicone rubber of the seal to provide a Shore A hardness scale value of substantially 15, or a Shore A hardness value of greater than or equal to substantially 15 Shore and less than or equal to substantially 20 Shore.

The skilled person will be familiar with the Shore hardness scale. The Shore A hardness scale measures the hardness of rubbers and/or semi-rigid plastics. Specifically, Shore hardness of a material may be measured using a Shore hardness gauge configured to measure the resistance of the material to indentation. The Shore hardness gauge may comprise a needle, which is placed against the material. A pressure is applied to the needle and a corresponding hardness measurement is determined based on the pressure capable of being applied to the material.

The inventors have appreciated that providing a seal comprising a material with substantially the above-mentioned hardness values allows robust enough connection to be formed with the main body 102 on attachment of the seal to the main body 102, while still allowing sufficient deformation of the seal against the face of the wearer to improve comfort and fit of the face mask 100 in use.

In exemplary arrangements, substantially the whole of the seal may comprise a material with a Shore A hardness scale value of substantially 15, or a Shore A hardness value of greater than or equal to substantially 15 Shore and less than or equal to substantially 20 Shore. In alternative arrangements, at least one of: the portion of the seal configured to extend between the main body 102 and the face of the wearer; and the walls 134a, 134b, may comprise a material with a Shore A hardness scale value of substantially 15. In further alternative arrangements, at least one of the portion of the seal configured to extend between the main body 102 and the face of the wearer, and the walls 134a, 134b, may comprise a material with a Shore A hardness value of greater than or equal to substantially 15 Shore and less than or equal to substantially 20 Shore.

In exemplary face masks, the main body 102 may comprise a material with a hardness value greater than the Shore A hardness value of the seal 104.

As described above, the face mask 100 may further comprise a filter 106. The filter 106 may be configured to prevent the ingress of airborne particles into the face mask 100. The filter is configured to allow the ingress and egress of air into the main body 102. The filter may be configured to provide a filter area sufficient to meet the breathing resistance requirements specified in standard EN 149.

The filter 106 may comprise a filter cap 140 and filter material 142. The filter material 142 may be configured to cover the filter aperture 114 of the main body 102. The filter material 142 may be retained between the filter cap 140 and the support trusses 120 of the main body 102. The filter cap 102 may resist substantial movement of the filter material 142 away from the main body 102 on an exhale of the wearer. The support trusses 120 may resist substantial movement of the filter material 142 into the cavity 112 on an inhale of the wearer.

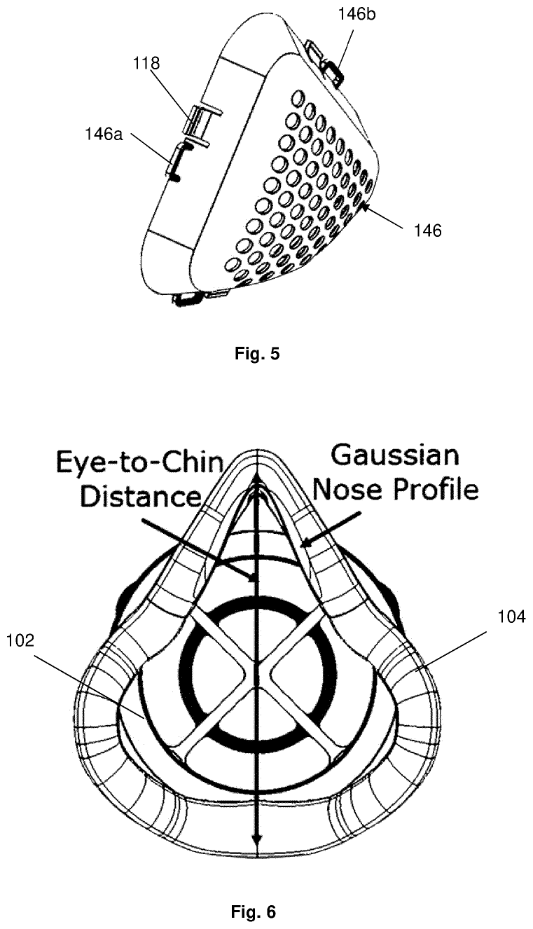

FIG. 5 shows the exemplary filter cap 140. The filter cap 140 may comprise a plurality of apertures 146. The plurality of apertures may provide protection against the ingress of large particles. That is, particles larger than the dimensions of the apertures. The plurality of apertures may be further configured to permit ingress of air into the main body 102 via the filter material 140. The exemplary filter cap 140 further comprises connection features 118, which have been described above.

The exemplary filter cap 140 comprises head strap connectors 146a, 146b configured to receive a head strap. The head strap connectors 146a, 146b may be configured to secure ends of the head strap to the face mask 100. The head strap connectors 146a, 146b may comprise an aperture through which an end of the head strap may pass or be clipped to. The head strap may be configured to secure the face mask 100 to the face of the wearer. The skilled person will appreciate that in alternative arrangements, the head strap connectors 146a, 146b may be provided on the main body 102 of the face mask.

Before use, the wearer of the face mask 100 may assemble the face mask 100.

In exemplary arrangements, the user may assemble the filter 106. That is, the filter material 142 may be received within the filter aperture 114 of the main body 102. The filter cap 140 may be connected to the main body 102. Connecting the filter cap 140 to the main body 142 may comprise engaging the connection features 118 of the filter cap 140 with the connection features 116 of the main body 102. In alternative arrangements, the filter material 142 and filter cap 140 may be fixedly connected to the main body 102, in which case the user may not need to assemble the filter 106.

The user may connect the seal 104 to the main body 102. Connecting the seal 104 to the main body 102 may comprise engaging the connection features 130 of the seal 104 with the connection features 126 of the main body 102. As described above, in exemplary arrangements, the connection features 130 of the seal 104 may comprise a channel 132 configured to receive a lip of the main body 102. In exemplary arrangements, at least one of the walls 134a, 134b of the channel may be resiliently deformable.

The at least one deformable wall may facilitate attachment of the seal 104 to the main body 102. For example, the at least one wall may be deformed to increase the gap between the opposed walls 134a, 134b such that the lip of the main body 102 may be received therein. Once the lip has been received within the channel 132, the at least one deformable wall may be released such that the gap formed by the opposed walls reduces and the lip is secured between the opposed walls 134a, 134b. As described above, the gap formed between the opposed walls 134a, 134b may be smaller than the thickness of the lip. As such, the lip may be secured within the channel 132 by a friction/interference fit with the walls of the channel.

In use, the face mask 100 may prevent the ingress of undesired particles into the main body 102. Ingress of undesired particles may be prevented by the filter 106 and the seal 104. The seal 104 may prevent the ingress of undesired particles at the interface between the face mask 100 and the face of the user. The filter 106 may prevent the ingress of undesired particles but allow the ingress of air to allow the wearer to breathe. The ingress of undesired particles through the filter aperture 114 of the main body may be prevented by the filter cap 140 and the filter material 142.

When the wearer has finished with the face mask, the seal 104 may be separated from the main body 102. The seal 104 may be separated from the main body by applying force to the main body 102 and/or seal 104 to deform the at least one deformable opposed wall 134a, 134b. This may increase the gap between the opposed walls 134a, 134b and allow removal of the lip of the main body 102 from the channel 132.

The seal 104 and the main body 102 may then be separately cleaned and/or disinfected before the next use of the face mask 100. For example, the seal 104 and the main body 102 may be soaked in separate cleaning/disinfectant baths. This provides a more effective cleaning and/or disinfection of the face mask when compared to face masks in which the main body and the seal are integral. In such arrangements, typically the only option is to wipe down the face mask, since different portions of the face mask require soaking in different solutions to avoid damage.

The exemplary seal 104 may be elastically deformable, as described above. As such, the seal may be removed from the main body and subsequently re-connected multiple times. This provides a reusable face mask 100, which may be effectively cleaned.

The inventors have realised that the portions of the seal configured to contact areas of the face with reduced soft tissue, such as the nose and chin, may benefit from increased seal thicknesses. This further reduces abrasions and bruising caused by the face mask.

In exemplary face masks 100, the seal 104 may comprise a minimum thickness. The thickness of the seal may comprise a minimum thickness of the portion of the seal 104 that extends between the main body 102 and the face of the user.

The minimum thickness of the portion of the seal configured to extend between the main body 102 and the face of the wearer may be one of substantially 3 mm, 4 mm, 5 mm, 6 mm, and 7 mm.

The portion of the seal configured to extend between the main body 102 and the face of the wearer in the nasal region may comprise a thickness greater than the minimum thickness. In exemplary face masks 100, the portion of the seal configured to extend between the main body 102 and the face of the wearer in the chin region may comprise a thickness greater than the minimum thickness. In exemplary face masks 100, the portion of the seal configured to extend between the main body 102 and the face of the wearer in a maxilla region may comprise a thickness greater than the minimum thickness.

For example, an exemplary face mask may comprise a minimum thickness of substantially 5 mm. That is, the minimum thickness of the portion of the seal 104 configured to extend between the main body 102 and the skin surface of the wearer may be substantially 5 mm. The thickness of the portion of the seal configured to extend between the main body 102 and the face of the wearer in the nasal region may be greater than 5 mm, for example, substantially 6 mm. The thickness of the portion of the seal configured to extend between the main body 102 and the face of the wearer in the chin region may be greater than 5 mm, for example, substantially 9 mm. The thickness of the portion of the seal configured to extend between the main body 102 and the face of the wearer in the chin region may be greater than 5 mm, for example, substantially 7 mm.

The above example is exemplary only and the skilled person will be able to envisage further arrangements.

In exemplary face masks, the channel 132 may be dimensioned such that at least a portion of the lip is received within the channel 132. In exemplary face masks 100, at least a portion of the lip may not be received within the channel 132 when the main body 102 is connected to the seal 104.

The inventors have realised that it is beneficial to reduce the extent to which the channel 132 overlaps the lip, when the lip is received therein. The amount of the lip received within the channel 132 be configured to allow a robust connection between the main body 102 and the seal 104. However, the inventors have realised that if the extent that the channel 132 overlaps the lip is too great, then the seal 104 may be lifted away from the face when force is applied to the face mask 100 to retain it against the face of the wearer.

In exemplary face masks, the channel 132 may be configured to receive one of: substantially 60% or less of a width of the lip; substantially 50% or less of a width of the lip; substantially 40% or less of the width of the lip; and substantially 30% or less of the width of the lip. The width of the lip encompasses the distance which the lip extends from the main body radially outwards.

In alternative arrangements, the channel 132 may be configured to receive the whole of the width of the lip, however the lip and channel 132 may be dimensioned such that the above-mentioned lifting of the seal 104 in use does not occur. In such arrangements, the width of the lip may be substantially 6 mm; substantially 5 mm; substantially 4 mm; substantially 3 mm or substantially 2 mm. The length of the walls of the channel 134a, 134b may be correspondingly dimensioned.

In further exemplary face masks 100, the nasal profile of the seal 104 may comprise a Gaussian curve. That is, at least a portion of the nasal profile of the seal 104 may be dimensioned such that it is defined by the relationship:

$$f ( x ) = {Ae}^{- \frac{{x}^{2}}{2 {σ}^{2}}}$$

where A is the height of the Gaussian curve and σ is the width of the Gaussian curve. The portion of the seal configured to contact the nose of the user may comprise a nasal profile geometry defined by the Gaussian curve, as shown in FIG. 6.

The inventors have realised that while not all of the population have nasal profiles that correspond to a Gaussian curve, most nasal profiles may be approximated to a Gaussian curve within +/−1 mm. This discrepancy may be accounted for by appropriate material selection for the face mask (for example, material with sufficient elasticity within the portion of the face mask configured to contact the skin surface of the user) and the elasticity of the tissue of the nose. As such, by determining a nasal profile geometry of the face mask based on a best-fit Gaussian curve, an improved seal in the nasal region may be provided. This reduces leakage around the nasal region.

The skilled person will be able to envisage further embodiments to those described above, which are intended only as examples, without departing from the scope of the appended claims.

1. A particle filtering face half mask configured to contact a nasal region, cheeks and a chin of a user, the particle filtering face half mask configured to provide respiratory protection, the face half mask comprising:
a main body configured to cover nostrils and a mouth of a user; and
a seal configured to form an interface between the main body and a skin surface of the user, the seal configured to prevent the ingress of undesired particles into the face half mask, and wherein the seal is releasably connectable to a perimeter of the main body.

2. A particle filtering face half mask according to claim 1, wherein one or both of the seal and the main body comprise connection features for releasable connection between the seal and the main body.

3. A particle filtering face half mask according to claim 2, wherein the connection features comprise a channel on one of the seal and the main body configured to engage a lip on the other of the seal and the main body.

4. A particle filtering face half mask according to claim 3, wherein the channel extends around a perimeter of the one of the seal and the main body, and the lip extends around a perimeter of the other of the seal and the main body.

5. A particle filtering face half mask according to claim 4, wherein the channel extends fully around the perimeter of the one of the seal and the main body, and the lip extends fully around the perimeter of the other of the seal and the main body.

6. A particle filtering face half mask according to claim 5, wherein at least one wall of the channel is configured to at least partially overlap the lip.

7. A particle filtering face half mask according to claim 3, wherein at least one wall of the channel is resiliently deformable.

8. A particle filtering face half mask according to claim 3, wherein the channel is a c-shaped channel.

9. A particle filtering face half mask according to claim 3, wherein the seal comprises the channel and the main body comprises the lip.

10. A particle filtering face half mask according to claim 1, wherein the seal is resiliently deformable.

11. A particle filtering face half mask according to claim 1, wherein the seal comprises a silicone material.

12. A particle filtering face half mask according to claim 1, wherein the seal comprises a material comprising a Shore A harness scale value of greater than or equal to substantially 15 Shore and less than or equal to substantially 20 Shore.

13. A particle filtering face half mask according to claim 1, wherein the hardness of the main body is greater than the hardness of the seal.

14. A particle filtering face half mask according to claim 1, wherein a portion of the seal configured to contact the skin surface of the user comprises a profile corresponding to the nasal region, cheeks and chin of the user.

15. A particle filtering face half mask according to claim 14, wherein the profile corresponds to the nasal region, cheeks and chin of the user in an undeformed configuration.

16. (canceled)

17. A particle filtering face half mask according to claim 1, wherein at least one of: a portion of the seal configured to extend between the main body and the chin of the user; a portion of the seal configured to extend between the main body and the nose of the user; and a portion of the seal configured to extend between the main body and a maxilla of the user is of a greater thickness than the minimum thickness.

18. A particle filtering face half mask according to claim 1, further comprising a filter.

19. A particle filtering face half mask according to claim 18, wherein the filter comprises a filter cap configured to receive filter material.

20. A particle filtering face half mask according to claim 19, wherein the filter cap is removably connectable to the main body.

21-24. (canceled)

25. A particle filtering face half mask according to claim 1 configured to provide protection against airborne pathogens.
